(19) United States
(12) Patent Application Publication
(10) Pub. No.: US 2018/0112052 A1
(43) Pub. Date: Apr. 26, 2018

(54) METHODS OF MANUFACTURING EXTRUDED POLYSTYRENE FOAMS USING CONDUCTIVE POLYMERS AS AN INFRARED ATTENUATION AGENT

(71) Applicant: Owens Corning Intellectual Capital, LLC, Toledo, OH (US)

(72) Inventors: Xiangmin Han, Stow, OH (US); Nikoi Annan, Canal Winchester, OH (US); Yadollah Delaviz, Lewis Center, OH (US)

(21) Appl. No.: 15/564,767

(22) PCT Filed: Apr. 28, 2016
(86) PCT No.: PCT/US16/29657

§ 371 Date: Oct. 6, 2017

Related U.S. Application Data
(60) Provisional application No. 62/153,559, filed on Apr. 28, 2015.

(51) Int. Cl. C08J 9/00; C08J 9/14; C08J 9/12; E04B 1/80

(52) U.S. Cl. CPC C08J 9/0061; C08J 2479/02; C08J 9/122; C08J 9/149; E04B 1/80; C08J 2201/03; C08J 2203/06; C08J 2203/162; C08J 2203/142; C08J 2203/182; C08J 2205/04; C08J 2205/05; C08J 2207/00; C08J 2325/06; C08J 2325/12; C08J 2465/00; C08J 9/146

(57) ABSTRACT

A composition and method for making extruded polystyrene (XPS) foam is provided. The composition includes an infrared attenuation agent composition comprising conductive polymers to achieve an XPS foam having an improved thermal insulation performance. In some exemplary embodiments, the conductive polymers comprise doped polypyrrole and doped polyanniline. In some exemplary embodiments, the XPS foam includes a carbon dioxide-based blowing agent.

### RELATED APPLICATIONS

This application claims the benefit of U.S. provisional application No. 62/153,559 filed on Apr. 28, 2015, titled METHODS OF MANUFACTURING EXTRUDED POLYSTYRENE FOAMS USING CONDUCTIVE POLYMERS AS AN INFRARED ATTENUATION AGENT which is incorporated herein by reference in its entirety.

### FIELD OF THE DISCLOSURE

The present disclosure relates to a composition and method for making extruded polystyrene (XPS) foam. Particularly, the present disclosure relates to an infrared attenuation agent composition comprising conductive polymers to achieve an XPS foam having an improved thermal insulation performance. In some exemplary embodiments, the conductive polymers comprise doped polypyrrole and doped polyanniline. In some exemplary embodiments, the XPS foam includes a carbon dioxide-based blowing agent.

### BACKGROUND

It is known that the overall heat transfer in a typical foam can be separated into three components: thermal conduction from gas (or blowing agent vapor), thermal conduction from polymer solids (including foam cell wall and strut), and thermal radiation across the foam. Schutz and Glicksman, J. Cellular Plastics, March-April, 114-121 (1984). As an independent pathway of heat transfer, thermal radiation occupies about 25% of the total transferred energy in the form of infrared light. Thus, it is desirable to seek materials that can attenuate infrared light by absorption, reflection, or diffraction.

An effective infrared attenuation agent (IAA) favors increased reflection and absorption and decreased transmission of heat radiation. Graphite has been proven to be an efficient IAA, and low levels of graphite (i.e., less than 5 wt. %) may improve the R-value by as much as 10-15%. However, graphite is an inorganic material, and the amount of inorganic material that is capable of being dispersed in a polymer foam may be limited. Moreover, the use of graphite may provide an undesireable color in the resulting polymer foam.

### SUMMARY

Various exemplary embodiments of the present invention are directed to a composition and method for making extruded polymeric foam. The composition and method for making extruded polymeric foam disclosed herein includes an infrared attenuation agent composition comprising conductive polymers to achieve an XPS foam having an improved thermal insulation performance. In some exemplary embodiments, the conductive polymers comprise doped polypyrrole and doped polyanniline. In some exemplary embodiments, the XPS foam includes a carbon dioxide-based blowing agent.

In accordance with some exemplary embodiments, a foamable polymeric mixture is disclosed. The foamable polymeric mixture includes a polymer composition, a blowing agent composition, and at least one infrared attenuating agent comprising a conductive polymer.

In accordance with some exemplary embodiments, a method of manufacturing extruded polymeric foam is disclosed. The method includes introducing a polymer composition into a screw extruder to form a polymeric melt, injecting a blowing agent composition into the polymeric melt to form a foamable polymeric material, and introducing at least one infrared attenuating agent into the polymeric melt, the at least one infrared attenuating agent comprising a conductive polymer, wherein the extruded polymeric foam exhibits an R-value of at least 4° F·ft2·hr/BTU per inch.

In accordance with some exemplary embodiments, an extruded polymeric foam is disclosed. The extruded polymeric foam comprises a foamable polymeric material, the material comprising a polymer composition, a blowing agent composition comprising carbon dioxide, and at least one infrared attenuating agent selected from doped polypyrrole and doped polyanniline, The extruded polymeric foam exhibits an R-value of at least 4° F·ft2·hr/BTU per inch.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic drawing of an exemplary extrusion apparatus useful for practicing methods according to the invention.

FIG. 2 shows the molecular structures of conductive polymers polypyrrole and polyanniline.

FIG. 3 shows the SEM particle morphology of doped polypyrrole and doped polyanniline.

FIG. 4 shows the influence of doped polypyrrole and doped polyanniline on the R-value of exemplary XPS foam boards.

FIG. 5 shows a color comparison of foam boards containing doped polyanniline (left, white) versus graphite (right, grey).

### DETAILED DESCRIPTION OF THE DISCLOSURE

A composition and method for making extruded polystyrene (XPS) foam is described in detail herein. The polymeric foam includes an infrared attenuation agent composition comprising conductive polymers to achieve an XPS foam having an improved thermal insulation performance. In some exemplary embodiments, the conductive polymers comprise doped polypyrrole and doped polyanniline. In some exemplary embodiments, the XPS foam includes a carbon dioxide-based blowing agent. These and other features of the extruded polymeric foam, as well as some of the many optional variations and additions, are described in detail hereafter.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “composition” and “inventive composition” may be used interchangeably herein.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

As used herein, unless specified otherwise, the values of the constituents or components of the IAA or other compositions are expressed in weight percent or % by weight of each ingredient in the composition. The values provided include up to and including the endpoints given.

As it pertains to the present disclosure, “closed cell” refers to a polymeric foam having cells, at least 95% of which are closed. However, in the present application, cells may be “open cells” or closed cells (i.e., certain embodiments disclosed herein may exhibit an “open cell” polymeric foam structure).

The general inventive concepts herein relate to a composition and method for making an extruded foam including an infrared attenuation agent composition comprising conductive polymers to achieve an XPS foam having an improved thermal insulation performance. In some exemplary embodiments, the conductive polymers comprise doped polypyrrole and doped polyanniline. In some exemplary embodiments, the XPS foam includes a carbon dioxide-based blowing agent.

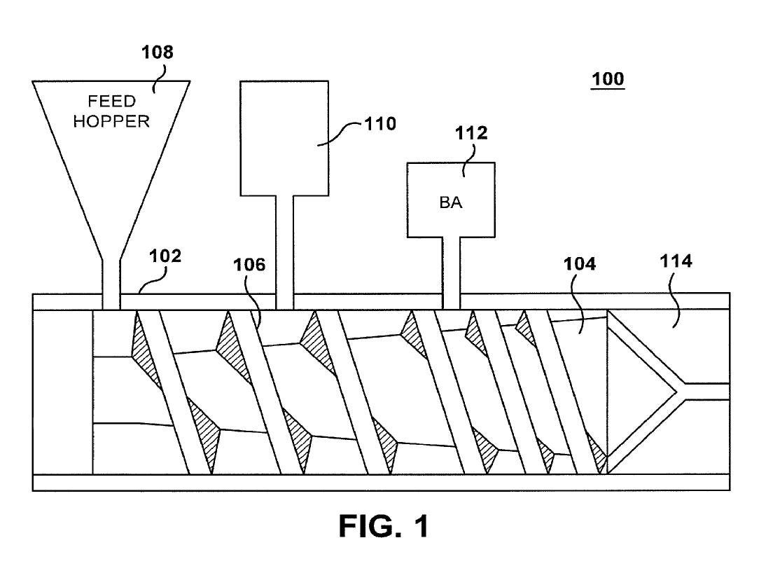

FIG. 1 illustrates a traditional extrusion apparatus 100 useful for practicing some exemplary embodiments of the present invention. The extrusion apparatus 100 may comprise a single or twin (not shown) screw extruder including a barrel 102 surrounding a screw 104 on which a spiral flight 106 is provided, configured to compress, and thereby, heat material introduced into the screw extruder. As illustrated in FIG. 1, the polymeric composition may be fed into the screw extruder as a flowable solid, such as beads, granules or pellets, or as a liquid or semi-liquid melt, from one or more feed hoppers 108.

As the basic polymeric composition advances through the screw extruder, the decreasing spacing of the flight 106 defines a successively smaller space through which the polymer composition is forced by the rotation of the screw. This decreasing volume acts to increase the pressure of the polymer composition to obtain a polymeric melt (if solid starting material was used) and/or to increase the pressure of the polymeric melt.

As the polymer composition advances through the screw extruder 100, one or more ports may be provided through the barrel 102 with associated apparatus 110 configured for injecting one or more infrared attenuating agents and/or one or more optional processing aids into the polymer composition. Similarly, one or more ports may be provided through the barrel 102 with associated apparatus 112 for injecting one or more blowing agents into the polymer composition. In some exemplary embodiments, the IAA composition disclosed herein, and/or one or more optional processing aids and blowing agents, are introduced through a single apparatus. Once the IAA composition and/or one or more optional processing aids and blowing agent(s) have been introduced into the polymer composition, the resulting mixture is subjected to some additional blending sufficient to distribute each of the additives generally uniformly throughout the polymer composition to obtain an extrusion composition. In some exemplary embodiments of the present invention, conductive polymers in powder form are pre-compounded with polystyrene to form a masterbatch.

This extrusion composition is then forced through an extrusion die 114 and exits the die into a region of reduced pressure (which may be below atmospheric pressure), thereby allowing the blowing agent to expand and produce a polymeric foam material. This pressure reduction may be obtained gradually as the extruded polymeric mixture advances through successively larger openings provided in the die or through some suitable apparatus (not shown) provided downstream of the extrusion die for controlling to some degree the manner in which the pressure applied to the polymeric mixture is reduced. The polymeric foam may be subjected to additional processing such as calendaring, water immersion, cooling sprays or other operations to control the thickness and other properties of the resulting polymeric foam product.

The foamable polymer composition is the backbone of the formulation and provides strength, flexibility, toughness, and durability to the final product. The foamable polymer composition is not particularly limited, and generally, any polymer capable of being foamed may be used as the foamable polymer in the resin mixture. The foamable polymer composition may be thermoplastic or thermoset. The particular polymer composition may be selected to provide sufficient mechanical strength and/or to the process utilized to form final foamed polymer products. In addition, the foamable polymer composition is preferably chemically stable, that is, generally non-reactive, within the expected temperature range during formation and subsequent use in a polymeric foam.

As used herein, the term “polymer” is generic to the terms “homopolymer,” “copolymer,” “terpolymer,” and combinations of homopolymers, copolymers, and/or terpolymers. Non-limiting examples of suitable foamable polymers include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyurethane, polyphenylene sulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends, and combinations thereof.

In one exemplary embodiment, the foamable polymer composition is an alkenyl aromatic polymer material. Suitable alkenyl aromatic polymer materials include alkenyl aromatic homopolymers and copolymers of alkenyl aromatic compounds and copolymerizable ethylenically unsaturated co-monomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer.

Examples of alkenyl aromatic polymers include, but are not limited to, those alkenyl aromatic polymers derived from alkenyl aromatic compounds such as styrene, styrene acrylonitrile (SAN) copolymers, alpha-methylstyrene, ethylstyrene, vinyl benzene, vinyl toluene, chlorostyrene, and bromostyrene. In at least one embodiment, the alkenyl aromatic polymer is polystyrene.

In certain exemplary embodiments, minor amounts of monoethylenically unsaturated monomers such as C2 to C6 alkyl acids and esters, ionomeric derivatives, and C2 to C6 dienes may be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

In certain exemplary embodiments, the foamable polymer melts may be formed substantially of (e.g., greater than 95 percent), and in certain exemplary embodiments, formed entirely of polystyrene. The foamable polymer may be present in the polymeric foam in an amount from about 60% to about 99% by weight, in an amount from about 70% to about 99% by weight, or in an amount from about 85% to about 99% by weight. In certain exemplary embodiments, the foamable polymer may be present in an amount from about 90% to about 99% by weight. As used herein, the terms “% by weight” and “wt %” are used interchangeably and are meant to indicate a percentage based on 100% of the total weight of all ingredients excluding the blowing agent composition.

Exemplary embodiments of the subject invention utilize a blowing agent composition. Any blowing agent may be used in accordance with the present invention. In some exemplary embodiments, carbon dioxide comprises the sole blowing agent. However, in other exemplary embodiments, blowing agent compositions that do not include carbon dioxide may be used. In some exemplary embodiments, the blowing agent composition comprises carbon dioxide, along with one or more of a variety of co-blowing agents to achieve the desired polymeric foam properties in the final product.

According to one aspect of the present invention, the blowing agent or co-blowing agents are selected based on the considerations of low GWP, low thermal conductivity, non-flammability, high solubility in polystyrene, high blowing power, low cost, and the overall safety of the blowing agent composition. In some exemplary embodiments, the blowing agent or co-blowing agents of the blowing agent composition may comprise one or more halogenated blowing agents, such as hydrofluorocarbons (HFCs), hydrochlorofluorocarbons, hydrofluoroethers, hydrofluoroolefins (HFOs), hydrochlorofluoroolefins (HCFOs), hydrobromofluoroolefins, hydrofluoroketones, hydrochloroolefins, and fluoroiodocarbons, alkyl esters, such as methyl formate, water, alcohols, such as ethanol, acetone, and mixtures thereof. In other exemplary embodiments, the blowing agent or co-blowing agents comprise one or more HFOs, HFCs, and mixtures thereof.

The hydrofluoroolefin blowing agent or co-blowing agents agents may include, for example, 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); (cis and/or trans)-1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO-1216); 2-fluoropropene, 1-fluoropropene; 1,1-difluoropropene; 3,3-difluoropropene; 4,4,4-trifluoro-1-butene; 2,4,4,4-tetrafluorobutene-1; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO-1336m/z); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-I-butene; 3,3-difluoro-I-butene; 3,4,4-trifluoro-I-butene; 2,3,3-trifluoro-1-butene; I, 1,3,3-tetrafluoro-I-butene; 1,4,4,4-tetrafluoro-1-butene; 3,3,4,4-tetrafluoro-1-butene; 4,4-difluoro-1-butene; I, I, 1-trifluoro-2-butene; 2,4,4,4-tetrafluoro-1-butene; 1,1,1,2-tetrafluoro-2 butene; 1,1,4,4,4-pentafluorol-butene; 2,3,3,4,4-pentafluoro-1-butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. In some exemplary embodiments, the blowing agent or co-blowing agents include HFO-1234ze.

The blowing agent or co-blowing agents may also include one or more hydrochlorofluoroolefins (HCFO), hydrochlorofluorocarbons (HCFCs), or hydrofluorocarbons (HFCs), such as HCFO-1233; 1-chloro-1,2,2,2-tetrafluoroethane (HCFC-124); 1,1-dichloro-1-fluoroethane (HCFC-141b); 1,1,1,2-tetrafluoroethane (HFC-134a); 1,1,2,2-tetrafluoroethane (HFC-134); 1-chloro 1,1-difluoroethane (HCFC-142b); 1,1,1,3,3-pentafluorobutane (HFC-365mfc); 1,1,1,2,3,3,3-heptafluoropropane (HFC-227ea); tnchlorofluoromethane (CFC-11); dichlorodifluoromethane (CFC-12); and dichlorofluoromethane (HCFC-22).

The term “HCFO-1233” is used herein to refer to all trifluoromonochloropropenes. Among the trifluoromonochloropropenes are included both cis- and trans-1,1,1-trifluo-3,chlororopropene (HCFO-1233zd or 1233zd). The term “HCFO-1233zd” or “1233zd” is used herein generically to refer to 1,1,1-trifluo-3,chloro-propene, independent of whether it is the cis- or trans-form. The terms “cis HCFO-1233zd” and “trans HCFO-1233zd” are used herein to describe the cis- and trans-forms of 1,1,1-trifluo,3-chlororopropene, respectively. The term “HCFO-1233zd” therefore includes within its scope cis HCFO-1233zd (also referred to as 1233zd(Z)), trans HCFO-1233zd (also referred to as 1233(E)), and all combinations and mixtures of these.

In some exemplary embodiments, the blowing agent or co-blowing agents may comprise one or more hydrofluorocarbons. The specific hydrofluorocarbon utilized is not particularly limited. A non-exhaustive list of examples of suitable HFC blowing agents or co-blowing agents include 1,1-difluoroethane (HFC-152a), 1,1,1,2-tetrafluoroethane (HFC-134a), 1,1,2,2-tetrafluoroethane (HFC-134), 1,1,1-trifluoroethane (HFC-143a), difluoromethane (HFC-32), 1,3,3,3-pentafluoropropane (HFO-1234ze), pentafluoro-ethane (HFC-125), fluoroethane (HFC-161), 1,1,2,2,3,3-hexafluoropropane (HFC 236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-245ca), 1,1,2,3,3-pentafluoropropane (HFC-245ea), 1,1,1,2,3pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof.

In some exemplary embodiments, the blowing agent or co-blowing agents are selected from hydrofluoroolefins, hydrofluorocarbons, and mixtures thereof. In some exemplary embodiments, the blowing agent composition comprises carbon dioxide and the co-blowing agent HFC-134a. In some exemplary embodiments, the blowing agent composition comprises carbon dioxide and HFO-1234ze. The co-blowing agents identified herein may be used singly or in combination.

In some exemplary embodiments, the total blowing agent composition is present in an amount from about 1% to about 15% by weight, and in exemplary embodiments, from about 3% to about 10% by weight, or from about 3% to about 9% by weight (based upon the total weight of all ingredients excluding the blowing agent composition).

The blowing agent composition may be introduced in liquid or gaseous form (e.g., a physical blowing agent) or may be generated in situ while producing the foam (e.g., a chemical blowing agent). For instance, the blowing agent may be formed by decomposition of another constituent during production of the foamed thermoplastic. For example, a carbonate composition, polycarbonic acid, sodium bicarbonate, or azodicarbonamide and others that decompose and/or degrade to form N₂, CO₂, and H₂O upon heating may be added to the foamable resin and carbon dioxide will be generated upon heating during the extrusion process.

The foamable composition disclosed herein contains at least one infrared attenuation agent (IAA) composition to increase the R-value of the foam product. The use of infrared attenuating agents is disclosed in U.S. Pat. No. 7,605,188. U.S. Pat. No. 7,605,188 is incorporated herein by reference in its entirety. In some exemplary embodiments, the infrared attenuating agent may be present in an amount from 0 to about 10% by weight, from 0 to about 3% by weight, from about 0.1 to about 2% by weight, or from about 0.2 to about 1.6% by weight (based upon the total weight of all ingredients excluding the blowing agent composition).

In accordance with the present disclosure, the at least one IAA composition comprises conductive polymers. It is known that conventional IAA compositions typically exhibit characteristics that conduct electricity (i.e., graphite, carbon black, and metal powders such as alumina or brass). Conducting polymers have a molecular backbone with conjugated structures. The shared electrons in the conjugated structures have the mobility to shift along the molecular chain, which is the mechanism for conducting electricity. As synthesized conductive polymers exhibit very low conductivities, it is not until an electron is removed from the valence band (p-doping) or added to the conduction band (n-doping) that a conducting polymer becomes highly conductive. Undoped conjugated polymers are typically semiconductors or insulators. After doping, the electrical conductivity increases by several orders of magnitude.

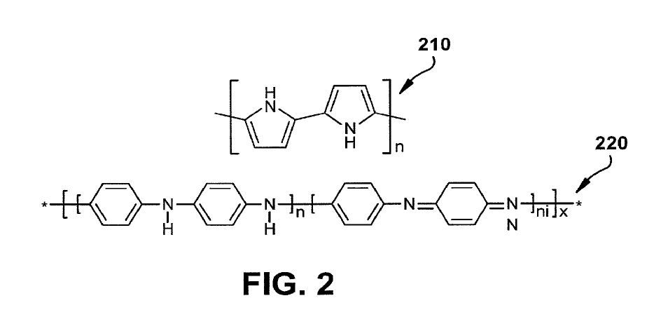

Thus, in accordance with some exemplary embodiments of the present invention, the conductive polymers comprise doped polypyrrole and doped polyanniline. The molecular structures of each of these polymers are shown in FIG. 2 (polypyrrole 210 and polyanniline 220).

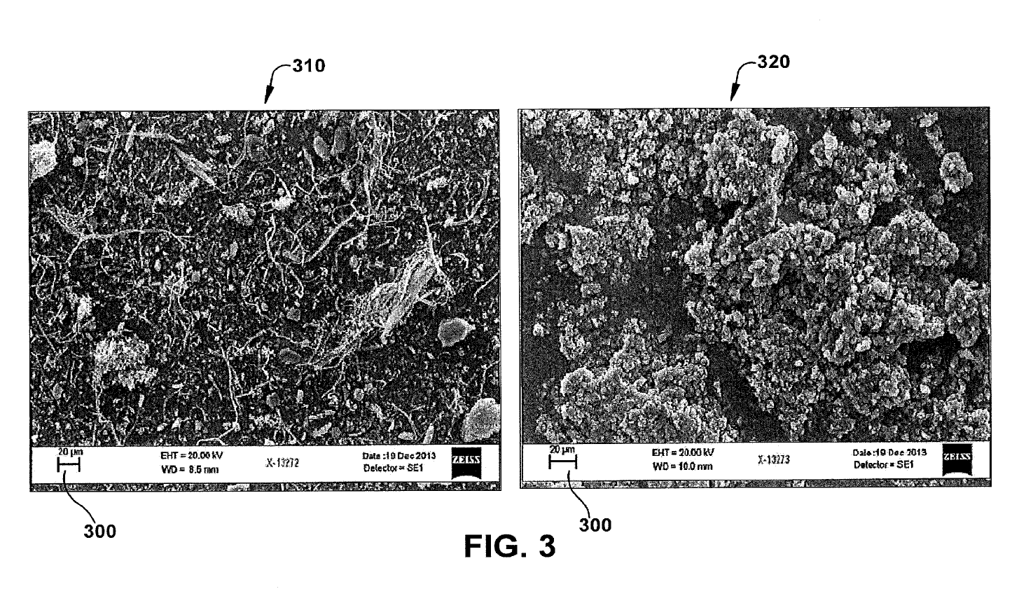

FIG. 3 shows the particle morphology of the two exemplary conductive polymers under SEM (doped polypyrrole 310 and doped polyanniline 320). As indicated in FIG. 3, the scale 300 represents 20 μm. In general, the exemplary conductive polymers are dark color powders. Polypyrrole 310 includes some fibrous structures, whereas polyanninline 320 includes fine, irregular particles.

In accordance with some exemplary embodiments of the present invention, the conductive polymers may comprise other conducting plastic materials that have the same or similar properties to doped polypyrrole and doped polyanniline, including, but not limited to, polyacetylene, poly(p-phenylene), polythiophenes, polytoluidines, and polyazines. See Handbook of Organic Conductive Molecules and Polymers (Hari Singh Nalwa ed., Vol. 2, 1997). In accordance with some other embodiments of the present invention, the conductive polymers may comprise radical conducting polymers, in which conduction properties are realized vy conjugated side groups attached on polymeric backbones.

The foam composition may further contain a fire retarding agent in an amount up to 5% or more by weight (based upon the total weight of all ingredients excluding the blowing agent composition). For example, fire retardant chemicals may be added in the extruded foam manufacturing process to impart fire retardant characteristics to the extruded foam products. Non-limiting examples of suitable fire retardant chemicals for use in the inventive composition include brominated aliphatic compounds such as hexabromocyclododecane (HBCD) and pentabromocyclohexane, brominated phenyl ethers, esters of tetrabromophthalic acid, halogenated polymeric flame retardant such as brominated polymeric flame retardant, phosphoric compounds, and combinations thereof.

Optional additives such as nucleating agents, plasticizing agents, pigments, elastomers, extrusion aids, antioxidants, fillers, antistatic agents, biocides, termite-ocide; colorants; oils; waxes; flame retardant synergists; and/or UV absorbers may be incorporated into the inventive composition. These optional additives may be included in amounts necessary to obtain desired characteristics of the foamable gel or resultant extruded foam products. The additives may be added to the polymer mixture or they may be incorporated in the polymer mixture before, during, or after the polymerization process used to make the polymer.

Once the polymer processing aid(s), blowing agent(s), IAA(s), and optional additional additives have been introduced into the polymeric material, the resulting mixture is subjected to some additional blending sufficient to distribute each of the additives generally uniformly throughout the polymer composition to obtain an extrusion composition.

In some exemplary embodiments, the foam composition produces rigid, substantially closed cell, polymer foam boards prepared by an extruding process. Extruded foams have a cellular structure with cells defined by cell membranes and struts. Struts are formed at the intersection of the cell membranes, with the cell membranes covering interconnecting cellular windows between the struts. In some exemplary embodiments, the foams have an average density of less than 10 pcf, or less than 5 pcf, or less than 3 pcf. In some exemplary embodiments, the extruded polystyrene foam has a density from about 1.3 pcf to about 4.5 pcf. In some exemplary embodiments, the extruded polystyrene foam has a density from about 1.4 pcf to about 3 pcf. In some exemplary embodiments, the extruded polystyrene foam has a density of about 2 pcf. In some exemplary embodiments, the extruded polystyrene foam has a density of about 1.5 pcf, or lower than 1.5 pcf.

It is to be appreciated that the phrase “substantially closed cell” is meant to indicate that the foam contains all closed cells or nearly all of the cells in the cellular structure are closed. In most exemplary embodiments, not more than 30% of the cells are open cells, and particularly, not more than 10%, or more than 5% are open cells, or otherwise “non-closed” cells. In some exemplary embodiments, from about 1.10% to about 2.85% of the cells are open cells. The closed cell structure helps to increase the R-value of a formed, foamed insulation product. It is to be appreciated, however, that it is within the purview of the present invention to produce an open cell structure, although such an open cell structure is not an exemplary embodiment.

Additionally, the inventive foam composition produces extruded foams that have insulation values (R-values) per inch of at least 4, or from about 4 to about 7. In addition, the average cell size of the inventive foam and foamed products may be from about 0.05 mm (50 microns) to 0.4 mm (400 microns), in some exemplary embodiments from 0.1 mm (100 microns) to 0.3 mm (300 microns), and in some exemplary embodiments from 0.11 mm (110 microns) to 0.25 mm (250 microns). The extruded inventive foam may be formed into an insulation product such as a rigid insulation board, insulation foam, packaging product, and building insulation or underground insulation (for example, highway, airport runway, railway, and underground utility insulation).

The inventive foamable composition additionally may produce extruded foams that have a high compressive strength, which defines the capacity of a foam material to withstand axially directed pushing forces. In at least one exemplary embodiment, the inventive foam compositions have a compressive strength within the desired range for extruded foams, which is between about 6 and 120 psi. In some exemplary embodiments, the inventive foamable composition produces foam having a compressive strength between about 10 and about 110 psi after 30 days aging.

In accordance with another exemplary aspect, the extruded inventive foams possess a high level of dimensional stability. For example, the change in dimension in any direction is 5% or less. In addition, the foam formed by the inventive composition is desirably monomodal and the cells have a relatively uniform average cell size. As used herein, the average cell size is an average of the cell sizes as determined in the X, Y and Z directions. In particular, the “X” direction is the direction of extrusion, the “Y” direction is the cross machine direction, and the “Z” direction is the thickness. In the present invention, the highest impact in cell enlargement is in the X and Y directions, which is desirable from an orientation and R-value perspective. In addition, further process modifications would permit increasing the Z-orientation to improve mechanical properties while still achieving an acceptable thermal property. The extruded inventive foam can be used to make insulation products such as rigid insulation boards, insulation foam, and packaging products.

As previously disclosed in detail herein, an IAA composition comprising conductive polymers achieves an XPS foam having an improved thermal insulation performance. In some exemplary embodiments, the IAA composition comprises doped polypyrrole and doped polyanniline. In some exemplary embodiments, by utilizing carbon dioxide as a blowing agent, these materials show comparable IAA effect as graphite, but with fewer disturbances for the foam properties. Likewise, these materials provide a lighter color in the resulting foam composition.

The inventive concepts have been described above both generically and with regard to various exemplary embodiments. Although the general inventive concepts have been set forth in what is believed to be exemplary illustrative embodiments, a wide variety of alternatives known to those of skill in the art can be selected within the generic disclosure. Additionally, following examples are meant to better illustrate the present invention, but do in no way limit the general inventive concepts of the present invention.

### EXAMPLES

A variety of extruded polystyrene (“XPS”) foams were prepared using a twin screw extruder. Polystyrene was melted in the extruder and then injected with various blowing agent compositions to form homogeneous solutions. The solution was then cooled to the desired foaming conditions. In some exemplary embodiments, the foaming die temperature was between 110° C. and 130° C., and the foaming die pressure was between 800 psi and 1200 psi. Foam boards were produced having a thickness of 1 inch and a width of 20 inches for the exemplary embodiments evaluated herein.

Varying amounts of the two exemplary conductive polymers were added in the hopper of the foam extruder, together with the PS resin, nucleation agent, and flame retardant. In the examples herein, carbon dioxide was used as the exclusive blowing agent. Because the foam boards evaluated herein had similar densities, the difference in the R-values is primarily, if not exclusively, due to the impact of the conductive polymers.

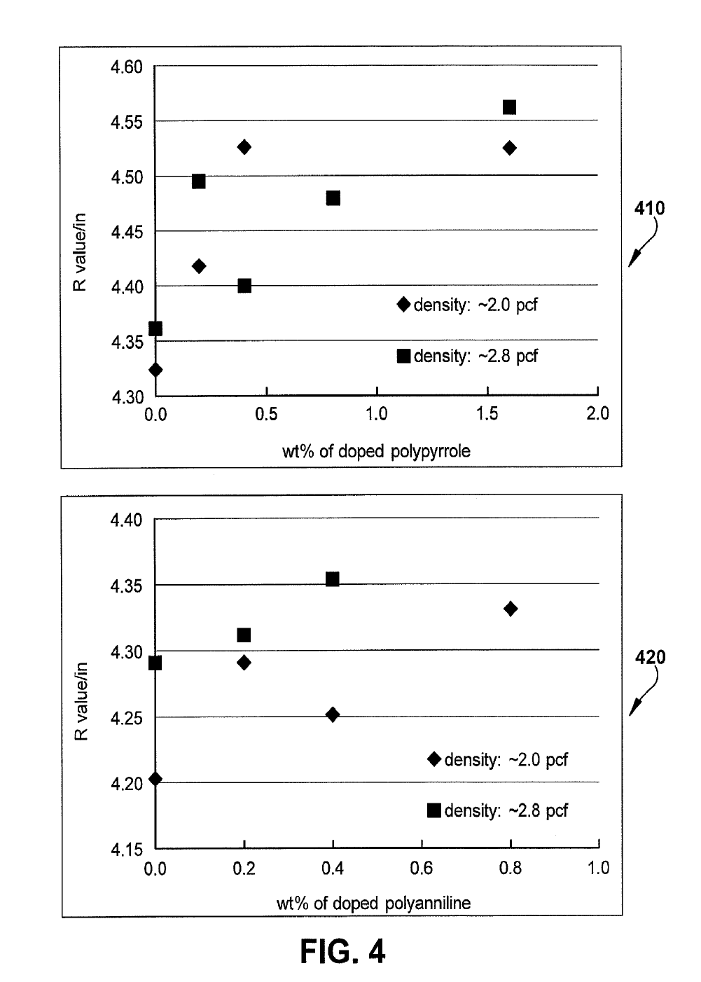

FIG. 4 summarizes the influence of doped polypyrrole 410 and doped polyanniline 420 on the R-value of the exemplary XPS foam. As shown in FIG. 4, as more conductive polymer was added, a higher R-value was obtained. The exemplary embodiments show that a 2% to 5% increase in the R-value may be obtained when the composition includes from 0.2% to 1.6% by weight of the conductive polymers as IAAs (based upon the total weight of all ingredients excluding the blowing agent composition).

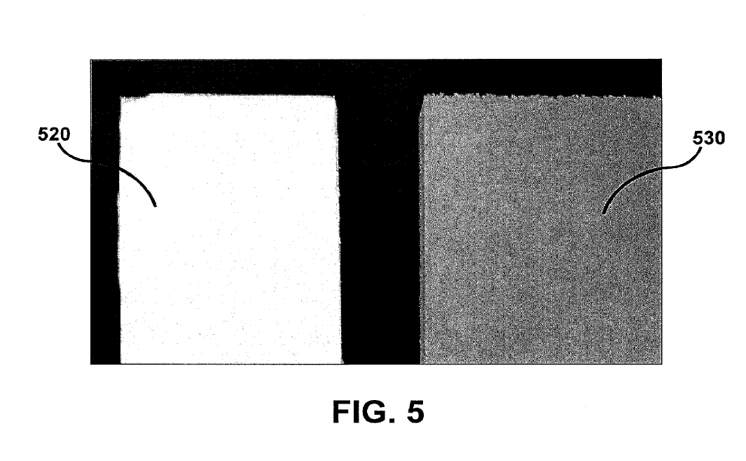

Additionally, the conductive polymers were found to diminish the change in color of the XPS foam board as compared to carbon-based IAAs utilized at the same weight percentage. FIG. 5 shows the appearance of an XPS foam board made with doped polyanniline 520 as compared to an XPS foam board made with graphite as the IAA 530 at the same weight concentration. The polyanniline board 520 remains nearly white, whereas the graphite board 530 exhibits a grey color. This difference makes XPS foam boards made with conductive polymers easier to dye to a desired color.

Tables 1 and 2 show other properties of the exemplary XPS foam boards made with doped polypyrrole and doped polyanniline in accordance with the present disclosure. The two exemplary conductive polymers showed mild nucleation capability, and an open cell content of less than 5%.

TABLE 1
Foam properties of XPS foam with doped polypyrrole (PPY).

| | Density | Cell size | Open cell | Compressive | Compressive |
|---|---|---|---|---|---|
| PPY % | (pcf) | (mm) | (%) | strength (psi) | modulus (psi) |
| 0 | 2.79 | 0.20 | 2.40 | 42.96 | 1212.5 |
| 0 | 2.02 | 0.23 | 3.76 | 23.95 | 554.7 |
| 0.2 | 2.73 | 0.18 | 3.27 | 38.41 | 961.8 |
| 0.2 | 1.98 | 0.19 | 4.61 | 22.95 | 560.1 |
| 0.4 | 2.73 | 0.14 | 4.24 | 42.63 | 1647.3 |
| 0.4 | 1.93 | 0.14 | 4.48 | 23.84 | 830.7 |
| 0.8 | 2.69 | 0.12 | 4.35 | 42.48 | 1388.2 |
| 0.8 | 1.92 | 0.14 | 5.46 | 23.01 | 736.8 |
| 1.6 | 2.65 | 0.12 | 5.03 | 44.13 | 1333.3 |
| 1.6 | 2.07 | 0.12 | 5.47 | 29.18 | 852.9 |

TABLE 2
Foam properties of XPS foam with doped polyanniline (PANI).

| PANI | Density | Cell size | Open cell | Compressive | Compressive |
|---|---|---|---|---|---|
| % | (pcf) | (mm) | (%) | strength (psi) | modulus (psi) |
| 0 | 2.78 | 0.19 | 2.51 | 42.6 | 1964.5 |
| 0 | 2.01 | 0.21 | 2.89 | 24.6 | 1149.3 |
| 0.2 | 2.78 | 0.16 | 1.91 | 43.6 | 1482.8 |
| 0.2 | 2.01 | 0.19 | 3.15 | 24.9 | 1037.8 |
| 0.4 | 2.89 | 0.18 | 3.02 | 40.6 | 1282.5 |
| 0.4 | 2.04 | 0.19 | 3.41 | 26.5 | 1003.7 |
| 0.8 | 2.26 | 0.17 | 2.75 | 31.7 | 1143.5 |

As used in the description of the invention and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the applicant's general disclosure herein.

What is claimed is:

1. A foamable polymeric mixture comprising:
a polymer composition;
a blowing agent composition; and
at least one infrared attenuating agent comprising a conductive polymer.

2. The foamable polymeric mixture of claim 1, wherein the at least one infrared attenuating agent comprises doped polypyrrole or doped polyanniline.

3. The foamable polymeric mixture of claim 1, wherein the blowing agent composition comprises carbon dioxide.

4. The foamable polymeric mixture of claim 3, wherein the blowing agent composition further comprises at least one co-blowing agent.

5. The foamable polymeric mixture of claim 4, wherein the at least one co-blowing agent is selected from hydrofluoroolefins, hydrofluorocarbons, and mixtures thereof.

6. The foamable polymeric mixture of claim 1, wherein the at least one infrared attenuating agent comprises from about 0.1% to about 2% by weight.

7. The foamable polymer mixture of claim 1, wherein the polymer composition comprises polystyrene or styrene acrylonitrile (SAN) copolymer.

8. A method of manufacturing extruded polymeric foam comprising:
introducing a polymer composition into a screw extruder to form a polymeric melt;
injecting a blowing agent composition into the polymeric melt to form a foamable polymeric material; and
introducing at least one infrared attenuating agent into the polymeric melt, the at least one infrared attenuating agent comprising a conductive polymer, wherein the extruded polymeric foam exhibits an R-value of at least 4° F·ft2·hr/BTU per inch.

9. The method of claim 8, wherein the at least one infrared attenuating agent comprises doped polypyrrole or doped polyanniline.

10. The method of claim 8, wherein the blowing agent composition comprises carbon dioxide.

11. The method of claim 10, wherein the blowing agent composition further comprises at least one co-blowing agent.

12. The method of claim 11, wherein the at least one co-blowing agent is selected from hydrofluoroolefins, hydrofluorocarbons, and mixtures thereof.

13. The method of claim 8, wherein the at least one infrared attenuating agent comprises from about 0.1% to about 2% by weight.

14. The method of claim 8, wherein the polymer composition comprises polystyrene or styrene acrylonitrile (SAN) copolymer.

15. An extruded polymeric foam comprising:
a foamable polymeric material, the material comprising:
a polymer composition;
a blowing agent composition comprising carbon dioxide; and
at least one infrared attenuating agent selected from doped polypyrrole and doped polyanniline,
wherein the extruded polymeric foam exhibits an R-value of at least 4° F·ft2·hr/BTU per inch.

16. The extruded polymeric foam of claim 15, wherein the polymer composition comprises polystyrene or styrene acrylonitrile (SAN) copolymer.
